(19) United States
(12) Patent Application Publication
(10) Pub. No.: US 2019/0100470 A1
(43) Pub. Date: Apr. 4, 2019

(54) HIGH-SPEED COMPOST FERMENTATION APPARATUS

(71) Applicant: TEACHANG BIO CO.,LTD., Jeollanam-do (KR)

(72) Inventor: Hyo-Jun JEON, Jeollanam-do (KR)

(73) Assignee: TEACHANG BIO CO.,LTD., Jeollanam-do (KR)

(21) Appl. No.: 15/545,683

(22) PCT Filed: Dec. 11, 2015
(86) PCT No.: PCT/KR2015/013604

§ 371 Date: Jul. 22, 2017

(30) Foreign Application Priority Data
Jan. 23, 2015 (KR) 10-2015-0011437

(51) Int. Cl. C05F 17/02

(52) U.S. Cl. CPC C05F 17/0247; C05F 17/0241; C05F 17/027

(57) ABSTRACT

A high-speed compost fermentation apparatus of the present invention comprises: a silo having a fermentation space provided therein, having an inlet provided at the upper part thereof, and having an outlet, for discharging fermented compost, formed at the lower part thereof; a stirring unit having driving parts provided to a frame, which is provided at a base part and supports the silo, first and second driving shafts driven by each driving part and provided inside the silo, and a plurality of stirring blades respectively provided to the first and second driving shafts in a radial direction so as to stir organic materials stored in the silo; and a measuring unit provided between the base part and the frame so as to measure the weight of the organic materials stored in the silo.

### TECHNICAL FIELD

The present invention relates to a high-speed fermentation apparatus, and more particularly, to a high-speed compost fermentation apparatus is capable of composting food waste, all kinds of by-products, hay, sawdust, chaff, etc., by stirring and fermenting them.

### BACKGROUND ART

Due to the rapid development of the industry and an increase in population, a large amount of food waste and night-soils, muck are excreting by home, restaurant, pen, etc. In particular, residues after food processing, for example, a variety of types of animal and vegetable remnants are generated from an industrial area in which food processing factories, etc. are crowded.

A variety of types of organic waste and animal and vegetable remnants, such as those described above, require a lot of cost according to processing. In particular, in the case of food waste, much attention is given to its processing because the ocean dumping of the food waste is prohibited. As one option, the composting of food waste is sought to enable reuse.

A compost fermentation apparatus has been disclosed in Korean Patent No. 101047386, and a high-speed compost fermentation apparatus having multiple shafts has been disclosed in Korean Patent No. 100453284.

The disclosed fermentation apparatus may includes a silo body, a distribution apparatus provided on the upper part of the silo body to distribute equally input organic materials to the silo body and to load them onto the silo body, an organic materials stirring apparatus provided inside the silo body and formed of rotating shaft and blade, a hydraulic driving system for driving the stirring apparatus, and an air supply pipe for supplying external air. The silo body is configured by combining two or more silos in any one of a figure-of-eight type or a triangular type or a clover type. Each of the silos includes the rotating shaft. A plurality of grooves is formed in the top and bottom of the blade. The blades have an upward slope with respect to a horizontal surface and are installed in the pivot with a phase difference of 120°.

However, such a conventional high-speed compost fermentation apparatus has a problem in that an input and an output cannot be accurately measured because the weight of organic materials stored in the silo body cannot be measured. In particular, there is a problem in that microbes for fermentation are not uniformly supplied to the inside of the silo body depending on the amount of fermentation. Furthermore, odor may be generated in the fermentation process. There is a problem in that the odor may pollute surrounding air because it is discharged to the outside.

Korean Patent Application Publication No. 2002-6265 discloses a fermentation apparatus, and Korean Patent Application Publication No. 1997-68863 discloses a method of composting organic materials by fermenting the organic materials using a stirring apparatus. Furthermore, Korean Patent Application Publication No. 2009-0116444 discloses a high-speed fermentation apparatus and a method of controlling the same.

### SUMMARY OF THE INVENTION

The present disclosure provides a high-speed compost fermentation apparatus, which is capable of controlling an input and an output by measuring the weight of compost that is being fermented, equally supplying air and microbes to compost that is being fermented, and preventing odor generated when fermentation is performed from being discharged to the outside.

Another the present disclosure provides a high-speed compost fermentation apparatus, which is capable of collecting combustible ammonia gas and using the outer circumference surface of a silo as an installation area for a solar energy generation apparatus.

A high-speed compost fermentation apparatus according to an exemplary embodiment of the present disclosure may include a silo having a fermentation space provided therein, having an inlet provided at upper part thereof, and having an outlet, for discharging fermented compost, formed at the lower part thereof, a stirring unit having driving part provided to a frame, which is provided at a base part and supports the silo, at least one driving shafts driven by the driving parts and provided inlet the silo, and a plurality of stirring blades provided in a radial direction of the driving shaft and connected to the rotation of the driving part, for stirring organic materials stored in the silo.

And the high-speed compost fermentation apparatus comprises a measuring unit provided between the base part and the frame so as t o measure the weight of the organic materials stored in the silo.

A high-speed compost fermentation apparatus according to an exemplary embodiment of the present disclosure may include a silo having a fermentation space provided therein; having an inlet provided at upper part thereof, and having an outlet, for discharging fermented compost, formed at the lower side thereof; a stirring unit having driving parts provide to a frame, which is provided at a base part and supports the silo, first and second driving shafts driven by each driving part and provided inside, the silo, and a plurality of stirring blades respectively provided to the first and the second driving shafts in a radial direction so as to stir organic materials stored in the silo.

And the high-speed compost fermentation apparatus comprises a measuring unit provided between the base part and the frame so as to measure the weight of the organic materials stored in the silo.

A high-speed compost fermentation apparatus according to an exemplary embodiment of the present disclosure may include the measuring unit provided oad cell between the base part and the frame of the driving part. In an air and microbe supply unit, a first supply pipe line is formed in a first driving shaft in a length direction, a first branch pipe line is formed in the stirring blade in such a way as to communicate with the first supply pipe line, a plurality of first discharge holes are formed on at least one side of the first supply pipe line and the first branch pipe line. In addition, a second supply pipe line is formed in a second driving shaft in a length direction, a second branch pipe line is formed in the stirring blade in such a way as to communicate with the second supply pipe line, and a plurality of second discharge holes is formed on at least one side of the second supply pipe line and the second branch pipe line.

First and the second supply pipes connected to the rotating the first driving shaft and the second driving shaft and a high-pressure supply part and microbe supply part connected to the first and the second supply pipes, for selectively supplying high-pressure air or microbes to the first driving shaft and the second driving shaft are included.

Furthermore, an odor removing unit may further include which is provided at the upper part of the silo and removes odor generated when the organic materials stored in the silo is fermented.

The high-speed compost fermentation apparatus according to the present disclosure can be smoothly perform management for composting organic materials and prevent gas generated when fermentation is performed from contaminating air due to the external discharge of the gas because it can accurately measure the input and output of the organic materials stored in the silo.

Furthermore, the high-speed compost fermentation apparatus of the present invention can equally mix microbes with organic materials and also improve fermentation efficiency because it can supply air (oxygen) and microbes for the fermentation of the organic materials through the pivot. Furthermore, the high-speed compost fermentation apparatus can produce active power by installing the sunlight generation modules capable of generating electric power using solar energy on the outer circumference surface of the silo.

### DESCRIPTION OF THE DRAWINGS

FIG. 1 is a cross-sectional view of a high-speed compost fermentation apparatus according to the present invention,

FIG. 2 is a side cross-sectional view showing an extract of an air and microbe supply unit which supplies air and microbes through first and second driving shafts shown in FIG. 1,

FIG. 3 is a side view showing another an exemplary embodiment of the air and microbe supply unit according to the present invention,

FIG. 4 is a cross-sectional view showing an exemplary embodiment of an odor removing apparatus.

### BRIEF DESCRIPTION OF THE INVENTION

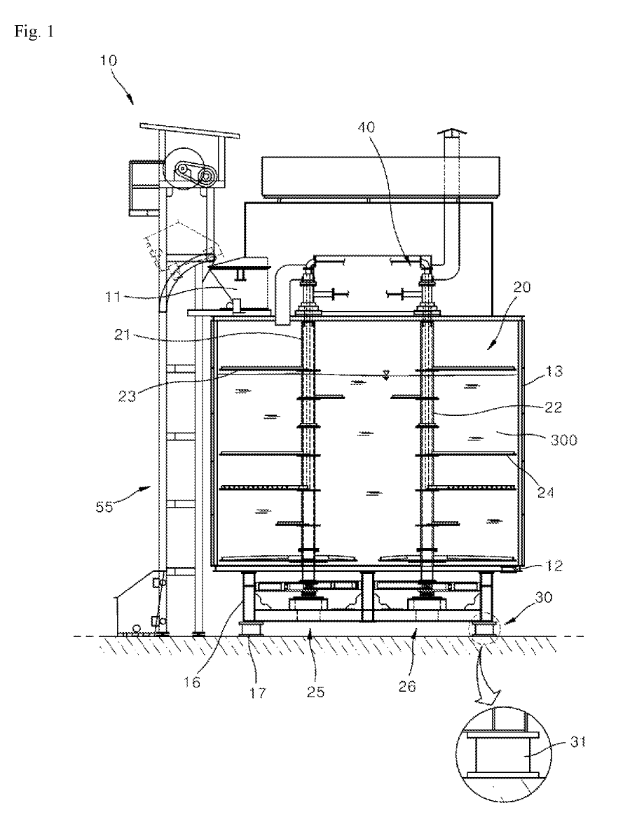

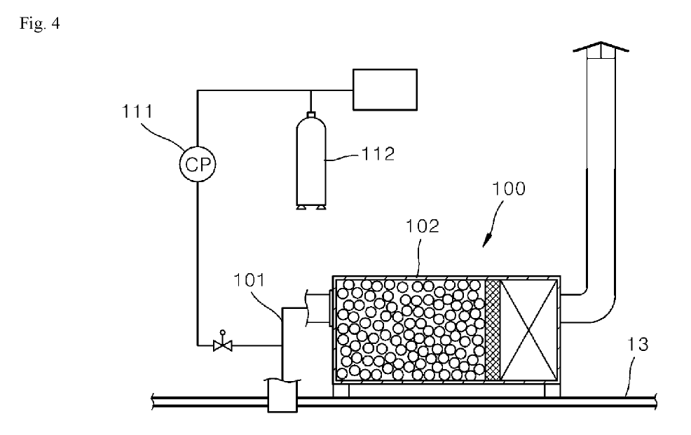

The high-speed compost fermentation apparatus of the present invention is capable of composting food waste, livestock manure, animal and vegetable byproducts, organic industrial waste, etc. by fermenting them, and an exemplary embodiment thereof is shown in FIGS. 1 to 4.

Referring to the drawings, the high-speed compost fermentation apparatus 10 according to the present invention may includes a silo 13 in which a fermentation space provided therein, having an inlet 11 provided at the upper part thereof, and having an outlet 12, for discharging fermented compost, formed at the lower part thereof. Furthermore, an elevator 55 for inputting organic materials 300 for fermentation to the inlet 11 is provided at the outer circumference surface of the silo 13. Furthermore, a frame 16 is provided at a base part 17 and supports the silo 13 under the silo 13.

Furthermore, a stirring unit 20 for stirring the organic materials input to the silo 13 is inlet provided in the silo 13 and the frame 16. Measuring means 30 is capable of metering the weight of the organic materials 300 stored in the silo 13 is provided between the base part 17 and the frame 16. Furthermore, air and microbe supply units 40 for supplying air (oxygen) and microbes through the first and second driving shafts of the stirring unit 20 are provide at the upper part of the silo 13. An odor removing unit 100 for removing odor generated when the organic materials 300 stored in the silo 13 is fermented is provided in the silo 13.

The high-speed compost fermentation apparatus configured as described above according to the present invention is described in more detail below for each element. The silo 13 may have a cross section of a circle or a non-circle and has an internal space in which the organic materials input to the silo can be sufficiently fermented. The cross section of the silo 13 may have a peanut shape whose circle is partially overlapped.

The stirring unit 20 is inlet provided the silo 13 and is for storing the organic materials 300 stored therein. The stirring unit 20 includes first and second driving shafts 21 and 22 spaced apart from each other at a specific interval. First and second stirring blades 23 and 24 for stirring the organic materials stored in the silo 13 when the organic materials is fermented are provided at the outer circumference surfaces of the first and the second driving shafts 21 and 22, respectively. The first stirring blades 23 is provided in the first driving shaft 21 and the second stirring blades 24 is provided at the outer circumference surface of the second driving shaft 22 are arranged on the outer circumference surface of the first driving shaft 21 and the outer circumference surface of the second driving shaft 22 at specific angle intervals. The first and the second stirring blades 23 and 24 are arranged so that interference is not generated between them when they are rotated. The first and the second stirring blades 23 and 24 may be formed to have a specific width and thickness, and the top surfaces and bottom surfaces of the first and the second stirring blades may be formed to have different curved surfaces or different slopes so that the stirring of organic materials is smoothly performed and the organic materials can be moved in a specific direction. However, the present invention is not limited thereto, and the first and the second stirring blades may be formed in various forms depending on the stirring condition of organic materials.

Furthermore, the first and the second driving shafts 21 and 22 are driven by first and second driving parts 25 and 26, respectively. A hydraulic driving system is adopted because the first and the second driving shafts 21 and 22 have a very great rotational load. In the hydraulic driving system, when pressure is supplied from a valve (not shown) controlling the supply of hydraulic pressure to a hydraulic cylinder, the piston rod of the hydraulic cylinder is externally pushed, so a latch attached to the end of the piston rod pushes 2 to 3 of the teeth of latch wheels disposed under the driving shafts of the stirring unit at a time, thereby rotating the driving shafts. Furthermore, the latch wheel may include means for preventing back lashing. The first and the second driving parts are not limited to the aforementioned exemplary embodiment and may have structures capable of once rotating the first and the second driving shafts every 15 to 30 minutes.

In the stirring unit 20, the driving shaft is inlet provided the silo may be one or a plurality of the driving shafts may be disposed in order to reduce the area in which stirring is not performed when the driving shaft is rotated. The number of driving shafts are inlet provided the silo may be different depending on a sectional shape of the silo.

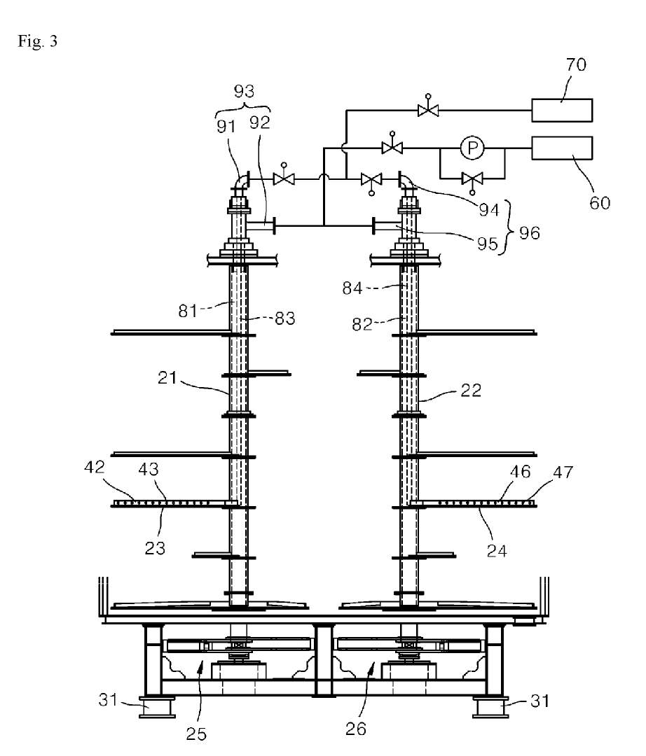

The measuring unit 30 is disposed between the base part 17 and the frame 16 and is for metering organic materials input to the silo 13, that is, organic matter that is fermented or input through the inlet 11 for fermentation. The measuring unit may include a plurality of load cells 31 (refer to FIG. 3). The metering of organic materials by the load cells 31 needs to be set so that the weight of the organic materials other than the basic weight of equipment, such as the silo 13, the frame 16 and the stirring unit, can be measured when initial setting is performed. The measuring unit may be provided between the frame 16 and the silo 13. In this case, it is preferred that the weight of the silo does not affect the first and the second driving shafts using journal bearings in the support parts of the driving shafts disposed in the silo.

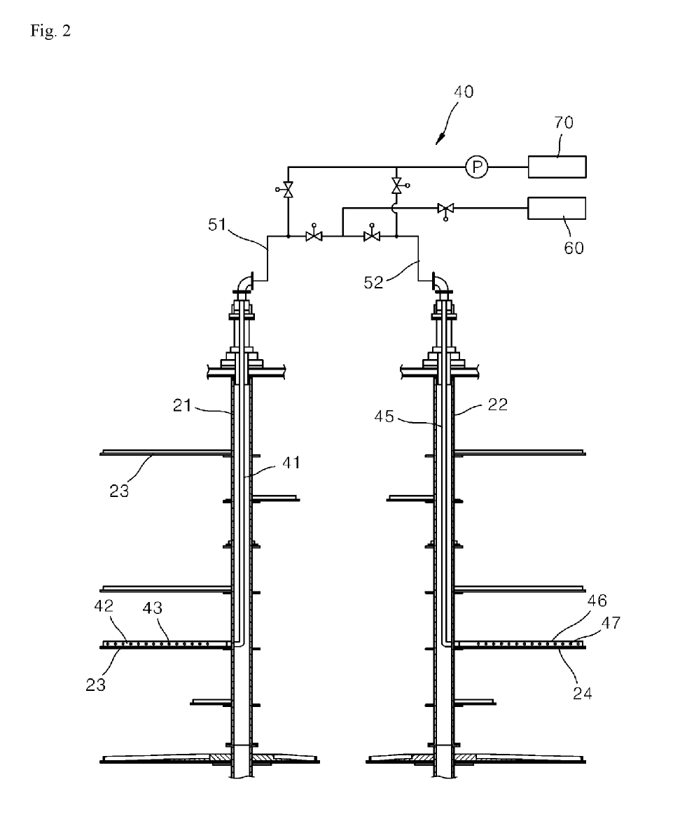

As shown in FIG. 2, the air and microbe supply unit 40 are for supplying microbes for fermentation with air through the first and the second driving shafts 21 and 22 and the stirring blades 23 and 24. In the air and microbe supply unit 40, a first supply pipe line 41 is formed in the first driving shaft 21 in the length direction thereof, a first branch pipe line 42 is formed in the first stirring blade 23 so that it communicates with the first supply pipe line 41, and a plurality of first discharge holes 43 is formed on at least one side of the first supply pipe line 41 and the first branch pipe line.

Furthermore, a second supply pipe line 45 is formed in the second driving shaft 22 in the length direction thereof, a second branch pipe line 46 is formed in the second stirring blade 24 so that it communicate with the second supply pipe line 45, and a plurality of second discharge holes 47 is formed on at least one side of the second supply pipe line 45 and the second branch pipe line 46.

Furthermore, there are provided first and second supply pipes 51 and 52 connected to the rotating first and second driving shafts 21 and 22 and a high-pressure supply part 60 and microbe supply part 70 connected to the first and the second supply pipes 51 and 52 to selectively supply high-pressure air or microbes to the first driving shaft 21 and the second driving shaft 22.

Meanwhile, FIG. 3 shows another an exemplary embodiment of the air and microbe supply unit.

Referring to the drawing, first and second hollows 81 and 82 are respectively formed in the first and the second driving shafts 21 and 22 in the length directions thereof, and first and second air supply pipes 83 and 84 are respectively disposed in the first and the second hollows 81 and 82. Furthermore, the end of the first air supply pipe 83 disposed in the first hollow part 81 is connected to the at least one first stirring blade 23 in which the first discharge holes 43 have been formed. The end of the second air supply pipe 84 disposed in the second hollow part 82 is connected to the at least one second stirring blade 24 in which the second discharge holes 47 have been formed.

Furthermore, first rotary joint 93 including first and second connection pipes 91 and 92 respectively connected to the first air supply pipe 83 and the first hollow part 81 is connected to the top of the first driving shaft, second rotary joint 96 including third and fourth connection pipes 94 and 95 respectively connected to the second air supply pipe 84 and the second hollow part 82 are connected to the top of the second driving shaft 23. Although not shown, the first hollow part and the second hollow part may communicate with the silo so that microbes can be supplied or may communicate with the stirring blades in which the discharge holes have been formed.

Furthermore, the first and the second connection pipes 91 and 92 are connected to the pneumatic supply part 60 by a supply pipe, and the second and the fourth connection pipes 94 and 95 are connected to the microbe supply part 70 by a supply pipe.

The pneumatic supply part 60 may include a ventilator or an air compressor. The microbe supply part 70 may include a liquefied microbe storage tank and a pump for pumping microbes within the microbe storage tank to the supply pipe. The microbe supply part is not limited thereto, and may include a common fission transfer unit so that microbes are climbed on high-pressure air and supplied if the microbes have a fission.

The odor removing unit 100 is for removing odor generated when the organic matter stored in the silo 13 provided at the upper part of the silo 13 is fermented, and includes a discharge pipe 101 for discharging odor generated inside the silo 13 and a carrier tank 102 which is connected to the discharge pipe 101 and in which microbe carriers for removing odor have been stored.

The odor removing unit may include a reaction top which has a reaction space therein, a processing gas supply unit which is connected to the reaction top by the discharge pipe of the silo and supplies processing gas to the reaction space, a liquid chemical storage tank which is provided under the reaction top and communicates with the reaction space, a liquid chemical supply pipe which connects the liquid chemical storage tank and a nozzle are provided in the reaction space of the reaction top so that a liquid chemical within the liquid chemical storage tank can be supplied to the nozzle, and a common scrubber which includes a liquid chemical supply unit including the supply pump disposed in the liquid chemical supply pipe. The liquid chemical for the processing gas may be different depending on the type of a contaminant (gas). For example, in the case of ammonia (NH₃), trimethylamine[(CH₃)₃N], methyl sulfide, dimethyl disulfide and acetaldehyde, H₂SO₄, HCL or NaOCl may be used as the liquid chemical. In the case of hydrogen sulfide or methyl mercaptan, NaOH or NaOCl may be used as the liquid chemical.

In another exemplary embodiment of the odor removing unit, although not shown, the spray of the liquid chemical is inlet provided at the upper part the silo 13 for removing odor may be performed by a spray nozzle disposed in a spray pipe and a supply pump capable of supplying the liquid chemical of the liquid chemical tank to the spray nozzle.

Meanwhile, if gas generated inside the silo 13 is inflammable gas, a gas compression unit 110 for compressing and storing the gas may be further included. The gas compression unit 110 may include a gas compressor 111 for compressing gas discharged through the discharge pipe and a storage tank 112 for storing the compressed gas.

Furthermore, photovoltaic power generation modules capable of generating electric power using solar energy may be installed on the outer circumference surface of the silo.

In the high-speed compost fermentation apparatus configured as described above according to the present invention, when the organic materials is input 11 to the silo 13 through the inside of the silo 13, the first and the second driving parts are driven to rotate the first and the second driving shafts 21 and 22. Accordingly, the organic materials 300 is stirred by the stirring blades disposed in the first and the second driving shafts 21 and 22 inlet the silo 13, and microbes and air (oxygen) are also supplied through the air and microbe supply units 40 disposed in the first and the second driving shafts. The organic materials subjected to fermentation processing through such a process is discharged through the outlet 12 provided at the lower part of the silo 13.

In such a process, the load cell 31 for metering are provided between the frame 16 and the base part 17, and are capable of precisely metering an input, the amount of organic materials fermented within the silo, and the output of fermented and composted organic materials. The output of compost can be calculated and the output can be efficiently managed.

Furthermore, surrounding atmosphere can be prevented from being polluted due to odor because odor generated in a fermentation process can be removed while passing through the tank in which carriers have been stored or the scrubber of the odor removing unit 100.

Furthermore, some electricity for lightening and driving the silo can be generated because the sunlight generation modules are installed on the outer circumference surface of the silo.

The present invention has been described with reference to the exemplary embodiments shown in the drawings, but this is only illustrative. A person having ordinary skill in the art will understand that various modifications and other equivalent exemplary embodiments are possible from the exemplary embodiments. Accordingly, the true technological range of protection of the present invention should be determined by the technological spirit of the following claims.

### INDUSTRIAL APPLICABILITY

The compost high-speed fermentation apparatus of the present invention may be widely applied to a variety of types of compost fabrication facilities, a variety of types of fermentation apparatuses, etc.

What is claimed is:

1. A high-speed compost fermentation apparatus, comprising:
a silo in which a fermentation space provided therein, having an inlet provided at the upper part thereof, and having an outlet, for discharging fermented compost, formed at the lower part thereof;
a driving part provided in a frame provided in a base part and supporting the silo;
at least one driving shaft driven by the driving part and provided inside the silo; and
a plurality of stirring blades are provided in a radial direction of the driving shaft and connected to the rotation of the driving part, for stirring organic materials within the silo,
wherein a measuring unit provided between the base part and frame so as to measure the weight of the organic materials stored in the silo.

2. The high-speed compost fermentation apparatus of claim 1, wherein the measuring unit comprises load cells provided between the base part and the frame of the driving part.

3. A high-speed compost fermentation apparatus, comprising:
a silo in which a fermentation space provided therein, having an inlet provided at the upper part thereof, having an outlet for discharging fermented compost, formed at the lower part thereof;
a stirring unit having driving parts provided to a frame, which is provided at a base part and supports the silo, first and second driving shafts driven by the each driving part and provided inside the silo, and a plurality of stirring blades respectively provided to the first and the second driving shafts in a radial direction so as to stir organic materials stored in the silo;, and
a measuring unit provided between the base part and the frame so as to measure the weight of the organic materials stored in the silo.

4. The high-speed compost fermentation apparatus of claim 2, wherein the measuring unit comprises load cells provided between the base part and the frame of the driving parts.

5. The high-speed compost fermentation apparatus of claim 2, wherein:
in an air and microbe supply unit, a first supply pipe line is formed in a first driving shaft in a length direction, a first branch pipe line is formed in the stirring blades in such a way as to communicate with the first supply pipe line, a plurality of first discharge holes is formed on at least one side of the first supply pipe line and the first branch pipe line, a second supply pipe line is formed in a second driving shaft in a length direction, a second branch pipe line is formed in the stirring blades in such a way as to communicate with the second supply pipe line, and a plurality of second discharge holes is formed on at least one side of the second supply pipe line and the second branch pipe line, and
the high-speed compost fermentation apparatus comprises:
first and the second supply pipes connected to the rotating first driving shaft and second driving shaft, and
a high-pressure supply part and microbe supply part connected to the first and the second supply pipes, for selectively supplying high-pressure air or microbes to the first driving shaft and the second driving shaft.

6. The high-speed compost fermentation apparatus of claim 2, further comprising an odor removing unit which is provided at the upper part of the silo and removes odor generated when the organic materials stored in the silo is fermented,
wherein the odor removing unit comprises a discharge pipe which discharges order generated within the silo and a carrier tank which is connected to the discharge pipe and in which microbe carriers for removing the odor have been stored.

7. The high-speed compost fermentation apparatus of claim 2, further comprising:
a suction pipe disposed within a discharge pipe or the silo,
a compressor connected to the suction pipe, for compressing gas, and
a gas compression unit comprising a storage tank which is connected to the compressor and stores compressed gas.

8. The high-speed compost fermentation apparatus of claim 2, wherein a sunlight generation module capable of generating electric power using solar energy is installed on an outer circumference surface of the silo.
